(19) United States
(12) Patent Application Publication
(10) Pub. No.: US 2016/0224970 A1
(43) Pub. Date: Aug. 4, 2016

(54) ELECTRONIC TRANSACTION FRAUD PREVENTION SYSTEM

(71) Applicant: Thandisizwe Ezwenilethu Pama, Sandton (ZA)

(72) Inventor: Thandisizwe Ezwenilethu Pama, Sandton (ZA)

(21) Appl. No.: 15/093,375

(22) Filed: Apr. 7, 2016

Related U.S. Application Data
(63) Continuation of application No. PCT/IB2014/065177, filed on Oct. 9, 2014.

(30) Foreign Application Priority Data
Oct. 9, 2013 (ZA) 2013/07531

(51) Int. Cl. G06Q 20/32; G06Q 20/42; G06Q 20/40

(52) U.S. Cl. CPC G06Q 20/3224; G06Q 20/4016; G06Q 20/42; G06Q 20/3229

(57) ABSTRACT

A fraud prevention system for electronic transactions. In the system, a server 12 implements a layered security methodology in which a number of authentication and authorisation processes must be completed successfully. These authentication processes are essentially: agent authentication—authentication of the authorising agent (the user, person or agent making the transaction authorisation request) by means of a hardware layer which links the known SIM identity of the agent to their verified identity; transaction authorisation—authorisation of the transaction by means of a challenge/response interactive layer; and location-based transaction verification—verification of transaction authorisation by means of a location layer in which the geographic location of the requesting device and the requested transaction are compared to ensure that the device and transaction are within a predetermined proximity.

### PRIORITY CLAIM

The present application is a continuation of International Application No. PCT/IB2014/065177, filed Oct. 9, 2014, which claims priority to South African Patent Application Serial No. 2013/07531, filed Oct. 9, 2013, both of which are incorporated herein by reference.

### FIELD OF THE INVENTION

This invention relates to a system and method to prevent fraud in electronic transactions conducted with the use of mobile devices.

An “electronic transaction” is any transaction conducted with the use or assistance of electronic or digital media or devices.

The term “transaction” is commonly used to describe any contractual exchange of value, typically involving the transfer of money or goods between people, businesses, accounts, devices such as ATMs and POS terminals or applications, such as transaction applications on mobile devices. The term “electronic transaction” is used herein in its widest possible sense and is not necessarily limited to the examples given in this paragraph.

To a large extent, this invention also relates to cybersecurity in that the invention finds application beyond transaction security and extends to a system and method of protection against the unauthorised use of digital or electronic data. In this regard, it will be appreciated that any authorisation process requires a supporting authentication process in which the identity of the authorising agent or person is authenticated to ensure that the authorisation is a valid authorisation provided by a properly authenticated agent or person.

### BACKGROUND TO THE INVENTION

The Federal Financial Institutions Examination Council (FFIEC) (a US organisation made up of the Board of Governors of the Federal Reserve System, the Federal Deposit Insurance Corporation, the National Credit Union Administration, the Office of the Comptroller of the Currency, and the Office of Thrift Supervision) has, since 2005, issued guidance documents promoting cybersecurity and authorisation based on valid authentication in internet banking environments. A key aspect of this guidance is that banks should employ layered and strong out of band security.

Whilst out of band security is currently used extensively in electronic transactions, the issue of layered security is not. The FFIEC guidance, for instance, is silent on the issue of layered security, other than requiring the implementation of more than simply a single check for security and authentication.

This invention seeks to address this shortcoming.

### SUMMARY OF THE INVENTION

According to this invention a system for preventing fraud in an electronic transaction comprises:
programmable logic means including a memory module, a communications module, an out of band module, a transaction authorisation module, a location module and an authorising module;
the communications module being configured to receive a request to process an electronic transaction authorisation initiated by a user of a mobile communications device;
the out of band module being configured, in response to receiving the request, to access the memory module to obtain a communications routing number associated with the mobile communications device;
the programmable logic means being configured to initiate a secondary communications session over a secondary communications channel with the mobile communications device and, by way of the communications module, to transmit a request for authorisation data to the mobile communications device and to receive authorisation data from the mobile communications device by way of the secondary communications channel, wherein if the authorisation data is successfully received then the out of band module confirming that agent authentication is successful;
the transaction authorisation module being configured to access the memory module to determine the status of a SIM card associated with the mobile communications device from which the authorisation data is received, the transaction authorisation module being configured to confirm that SIM authentication is successful based on the SIM status stored in the memory module;
the location module being configured to compare the geographic location of the mobile telephone at the time agency authentication is completed with an initiation location, being the geographic location from where the financial transaction is initiated, wherein if the geographic location of the mobile communications device is within a predetermined proximity to the initiation location then confirming that location-based transaction verification is successful; and
the authorising module being configured to authorise the requested financial transaction only if all of agent authentication, SIM authentication and location-based transaction verification are successful.

In the preferred form of the invention, the communications module is configured to receive electronic transaction authorisation processing requests initiated by a user of both financial services and a mobile communications device.

The transaction authorisation module is conveniently configured to obtain the identification of the SIM and to store the SIM identification data in the memory module and to update the SIM status field when, in use, the user registers for use of the fraud prevention system. The unique identity of the SIM is preferably the international mobile subscriber identity (IMSI), which is a unique number used by the network operator to identify the user as a particular subscriber.

The system of the invention dispenses with the need to store anything more than “verified” or “unverified” status data in respect of the SIM and the transaction authorisation module is preferably configured to change the SIM status stored in the memory module to “unverified” and to prompt the system to implement a user identity verification process when, in use, the user does a SIM swap.

The location module may use either or both radio signals between several radio towers of a mobile network and the mobile communications device and GPS to determine the geographic location of the mobile communications device.

Also, the location module determines the initiation location of the financial transaction by accessing a memory and retrieving the stored location of a point of sale (POS) terminal from which the financial transaction authorisation request was received.

Alternatively, the location module could determine the initiation location of the financial transaction by determining the geographic location of a computer on a network from where the financial transaction authorisation request originated.

The invention includes a method of preventing fraud in an electronic transaction, the method comprising the steps of:
in response to receiving a financial transaction authorisation request, accessing a memory to obtain a mobile communications device number associated with a user and for initiating a secondary communications session over a secondary communications channel with the mobile communications device;
in the secondary communications session, transmitting a request for authorisation data, via the communications module, to the mobile communications device and receiving authorisation data, via the communications module, from the mobile communications device via the secondary communications channel, wherein if the authorisation data is successfully received then confirming that agent authentication is successful;
accessing a memory to check the status of a SIM card associated with the mobile communications device from which the financial transaction authorisation is performed, wherein SIM authentication is successful based on the status stored in the memory;
comparing the geographic location of the mobile telephone at the time the agent authentication is completed with an initiation location, being a geographic location from where the financial transaction was initiated, wherein if the geographic location of the mobile communications device is within a predetermined proximity to the initiation location then confirming that location-based transaction verification is successful; and
authorising the requested financial transaction only if all of the agent authentication, SIM authentication and location-based transaction verification are successful.

### BRIEF DESCRIPTION OF THE DRAWINGS

in the drawings:

FIG. 1 is a simplified block diagram of one example of a multi-layered verification and authentication system according to the invention; and

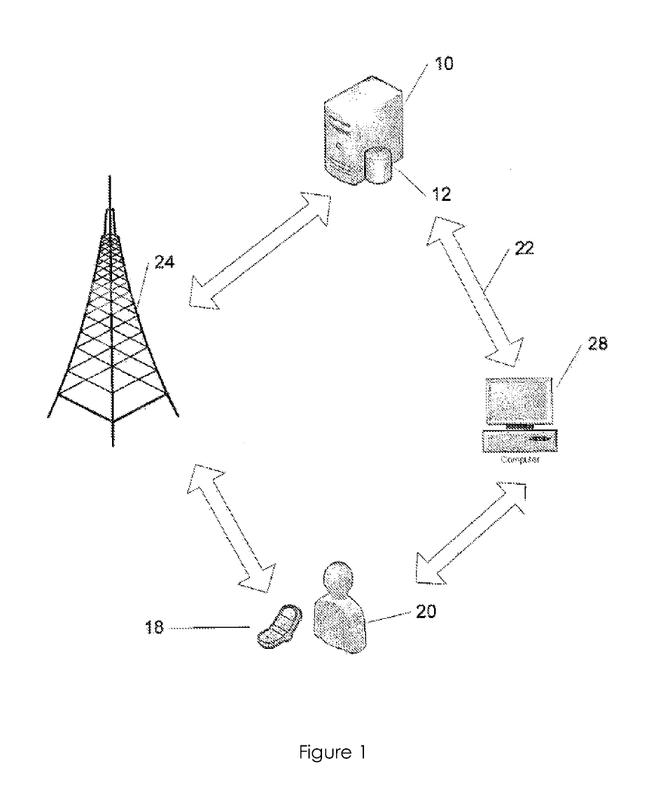

FIG. 2 is a simplified block diagram of the server of FIG. 1.

### DESCRIPTION OF EMBODIMENTS OF THE INVENTION

The electronic fraud prevention system of this invention will be described with reference to a system for securing electronic transactions, particularly electronic payments and electronic fund transfers. It will be appreciated that this is but one example of the multiple potential applications of the invention.

In the following description, for purposes of explanation, specific details are provided in places to provide an understanding of one embodiment of the invention. It will be evident however that the present invention may be practised with the use of alternative but equivalent devices and processes.

Referring to the drawings, the fraud prevention system of the invention has, at its core, a programmable logic device constituted by a computer provisioned as a server 10 with an associated memory in the form of a database 12.

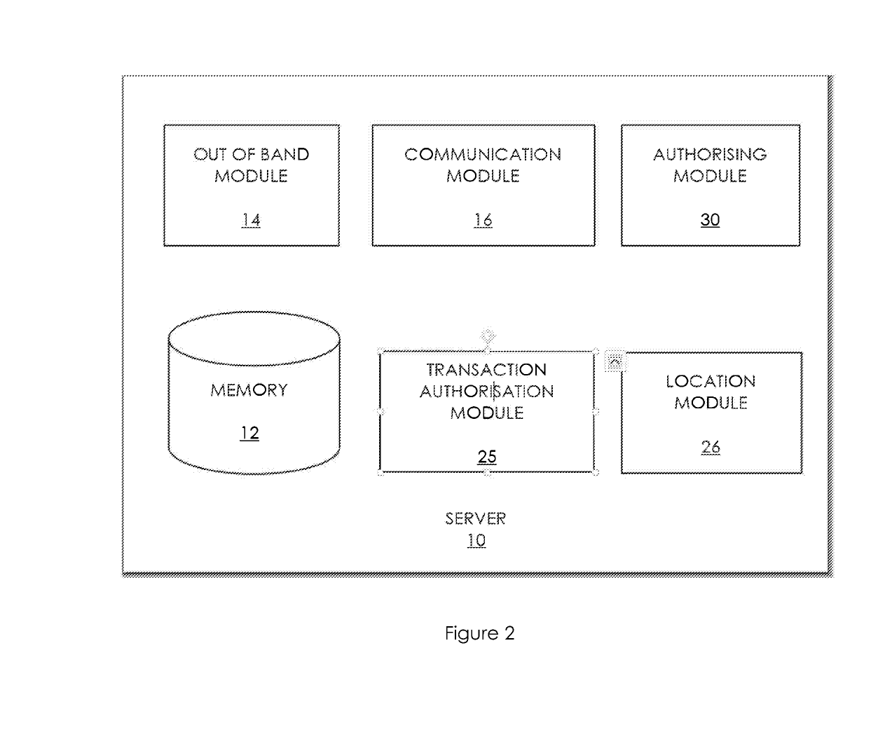

The server 10 includes a plurality of modules as shown in FIG. 2.

In one embodiment of the invention, these modules may be implemented by a machine-readable medium embodying instructions which, when executed by a machine, cause the machine to perform any of the methods described above. In another embodiment the modules may be implemented using firmware programmed specifically to execute the method described herein. It will be appreciated that embodiments of the present invention are not limited to such architecture and could equally well find application in a distributed or peer-to-peer architecture. Thus the modules illustrated could be located on one or more servers operated by one or more institutions.

It will also be appreciated that in any of these cases the modules may form a physical apparatus with physical modules specifically for executing the steps of the method described herein.

In the context of this specification, layered security in an electronic transaction authorisation process requires the use of different controls or interventions at different transaction times or transaction points to ensure that a weakness in one control is compensated by the strength of a different control.

The server 10 implements a layered security methodology whereby, before a transaction is authorised, a number of authentication and authorisation processes (interventions or control layers) must be completed successfully, failing which the authorising agent will not be authenticated or the transaction will not be authorised.

These authentication processes will be described below and are essentially:
agent authentication|authentication of the authorising agent (the user, person or agent making the transaction authorisation request) by means of a hardware layer (which links the known SIM identity of the user, person or agent to their verified identity);
transaction authorisation|authorisation of the transaction by means of an interactive layer; and
location-based transaction verification|verification of transaction authorisation by means of a location layer.

Each of these processes will be described below in more detail.

Referring first to agent authentication, the hardware layer links the mobile device SIM card to an authorising agent—the person or mobile device user making the authorisation request. This must be an authorising agent with a verified identity—verified by means of a previously implemented customer identification or verification programme.

In such a customer identification programme, the Subscriber Identity Module (SIM) card inside the mobile device and the identity of the mobile device subscriber (typically the user in possession of a SIM card) are determined and verified.

In this regard, the two relevant identities to be considered are: IMSI and MSISDN. A third identity, the IMEI, may be used. The decision to use the IMEI is based on the user's device use profile, relating to the frequency of user device changes. The IMEI is the mobile device identity which is burned into the device firmware.

The IMSI is the identity of the SIM card and the MSISDN is the device “phone” number. They are different numbers. The IMSI is used by the operator to identify a particular subscriber. The MSISDN is used to route calls, messages, network traffic and other communications to the device containing the SIM card associated with that MSISDN.

A subscriber becomes a customer of an operator by buying the SIM card of the operator. At this point the subscriber is allocated an IMSI and an MSISDN. The IMSI, which is burned into the SIM card is used by the operator to identify the subscriber. The MSISDN is the number which is used for routing communications such as phone calls, network traffic and GSM messaging traffic to the mobile device.

When a mobile device is switched on and when it moves from cell to cell within the cellular network, the device must be identified, for which the network uses the IMEI.

Each time the device reconnects to the network, for instance when the device has been switched off and on, the operator needs to identify and authenticate the subscriber. This is done using the IMSI, which is supported by user entry of a PIN. Only then will the mobile device be able to use the network services.

Before engaging in the customer identification programme, the user is first informed, through reliable means, of the impending customer identification programme and the terms and conditions of the programme. This can be done for instance, through transaction slips (such as ATM slips or POS slips), transaction notification messages (such as SMS or online banking notices), or some or other means of customer notification (such as a customer awareness and/or education programme).

The customer identification programme is repeated whenever a SIM swap occurs, in which event the user is sent a notification message immediately upon new SIM activation, informing the user of the requirement for customer identification and the terms and conditions to the customer identification programme.

Users are encouraged to use trusted channels like banking tablet apps, mobile apps, USSD channels, online banking, SIM Toolkit (STK) or mobile banking channels to work through the customer identification programme within a prescribed period. Upon first implementation by a user of the layered security service of this invention or any new service that requires first time customer identification, the prescribed period can be set at the discretion of the organization/institution requiring customer identification. However in SIM swap or SIM activation processes, the prescribed period should ideally be short—within 24 to 72 hours. During this time the user should not be allowed to undertake or process any sensitive transaction and must be informed of the need to go through the customer identification programme every time the user attempts to perform such a sensitive transaction. At the expiry of the prescribed period, the organization/institution should impose a penalty (for instance a lockout or non-use penalty) that makes it difficult for the user to continue without going through the customer identification programme and the user should be informed continually of the risks posed by continuing without customer identification, by means of warning for instance about potential personal liability, loss of insurance cover or the like.

When the customer identification programme is implemented over the Internet or a banking app, the user will be taken through a sequence of questions aimed at verifying the identity of the user.

This could also be done via an outbound phone call with a consultant asking the questions or an Interactive Voice Response (IVR) system. However, in these situations, the user and the bank will have to engage in a mutual authentication process of the bank's choosing prior to undertaking the customer identification programme, first to reassure the user that they are indeed speaking to their real bank and second, for the bank to verify that it is speaking to the real user.

A substantially more secure process would be to make use of USSD or STK in the customer identification programme, as explained in more detail below. A USSD code or a link on the STK could be used to prompt the system to deliver a sequence of questions through GSM messaging, by means of USSD/STK, WAP push or the like, to determine and verify the identity of the user.

Alternatively, the messaging could be initiated from the institution performing the customer identification by way of messaging sent to the user's mobile phone via USSD, STK, WAP push or the like.

To enhance the security of the customer identification programme, the system should ideally present multiple customer identification programme questionnaires to the user, with the user being asked to choose a questionnaire out of multiple options, without knowing what is behind each option.

In essence, the customer identification programme is a list of questions that serve to verify the identity of a user. The answers to the questions will consist of a mix of known user identification information, account details, address details, account history, transaction history, branch information and the like. For convenience, the information is arranged in questionnaires such that multiple lines of questions can be created for online or through GSM message delivery channels.

Different institutions use different Know-Your-Customer (KYC) systems and programmes and the customer identification programme referred to above could be aligned with such KYC programmes to meet the institution's KYC compliance requirements.

In the questionnaire system outlined above, questionnaires are preferably not repeated and once used, are left unused for a multiplicity of customer identification programmes before the same questionnaire or questionnaire content is used again, possibly with different and/or modified questions.

By employing a system of rendering unusable recently used and failed questionnaires, this serves to protect the user from being tricked into revealing information in a potentially bogus customer identification programme through phishing or other means aimed at tricking the user into revealing identifying information to unauthorised third parties. In such a process, the system will render unusable all recently used questionnaire information and all failed customer identification programme questionnaires (or only some failed customer identification programme questionnaires, for instance one, two or three failures—with the failure number being large enough to preserve system integrity but small enough to avoid overburdening the system).

Any failure of the user successfully to navigate the customer identification programme will result in the user being required to visit the bank with a view to undertaking the customer identification programme in person.

During the customer identification programme the user is also asked to choose a PIN. This is the PIN the user will use for all transaction authentications, until such time that the user undertakes another customer identification programme or is requested to change the PIN over a reliable channel where identity can be verified.

The outcome of a customer identification programme therefore should include the following:
a verified user ID
the user ID should be linked to a unique SIM
a user selected PIN should be chosen for all out of band authentication
the result being a security-ready user

To implement the customer identification programme, the server 10 includes a out of band module 14 and a communications module 16.

In use, the communications module 16 receives a financial transaction authorisation request by way of a conventional communications channel, which triggers the process for the authorisation of a financial transaction.

Another aspect of the customer identification program would include the authenticated submission of required KYC documents over a reliable channel, such as the reliable channels indicated above.

### Agent Authentication

In the layered security process of the invention, the out of band module 16 first implements agent authentication.

In response to the transaction authorisation request, the out of band module 16 accesses the memory 12 to obtain the MSISDN of the appropriate mobile communications device, typically a mobile phone 18, associated with a user 20. The user is normally the transaction originator.

The MSISDN will have been stored in the memory 12 in the customer identification programme referred to above, which is a registration process that will require the user 20 to register to use the fraud prevention system.

In one specific example, this will require the user to access the communication module 16 of the server 10 via a communication network, which may be a publicly switched communications network (PSTN) 22, a mobile communications network 24 or any other suitable communications network.

The registration process requires the user 20 to provide the server 10 with a unique identifier for the mobile phone 18 that the user will be using for financial transactions, which is the device that the user will register in the authentication process described below. In the example illustrated, the device is a mobile phone 18. For mobile communication devices, the unique identifier, conventionally, will be the MSISDN—the phone number of the mobile phone 18.

The phone number (MSISDN) of the mobile phone 18 is then stored in memory 12 and associated with the data recorded in respect of the user 20 during the customer identification programme.

As part of the agent authentication process and on receipt of the financial transaction authorisation request, the out of band module 14 also initiates a secondary communications session over a secondary communications channel with the mobile phone 18.

In one embodiment of the invention, this secondary communications session is an Unstructured Supplementary Services Data (USSD) communications session in what is referred to as a network initiated USSD communications session (NIUSSD).

USSD is a communications protocol used by GSM cellular telephones to communicate with computers of their associated GSM service providers. Unlike Short Message Service (SMS) which uses a store-and-forward mode of data exchange, a real-time connection is created during a USSD session that remains open, allowing bidirectional data exchange. USSD Phase 2 as specified in GSM 03.90 supports network-initiated (“push”) operation and is the out-of-band communications protocol that is used for purposes of communications on the secondary channel that is used in the method and system of this invention. For purposes of this invention SMS may be used for authentication when used as an encrypted data bearer for the SIM toolkit. This would provide a secure uninterrupted session with the user device.

In the USSD communications session, a request is transmitted for agent authentication data to the mobile communications network to initiate the USSD session with the mobile communications device (phone 18).

The agent authentication data requested could take a number of forms. For example, the agent authentication data could be a PIN which the user is required to input into the USSD session. The PIN will have been captured during the registration process or customer identification programme and associated with the user.

Alternatively, the agency authentication data could simply be a request to select Yes or No or “1” for YES or “2” for NO, since the user, at this stage of the process, being required to do little more than manually select something on their mobile phone 18. Upon choosing NO, the process ends, however upon YES, a PIN is required.

In the agent authentication process, therefore, the out of band module 14 transmits a request for authentication data, via the communications module 16, to the mobile phone 18 and receives agent authentication data, via the communications module 16, from the mobile phone 18 via the secondary communications channel.

If the agent authentication data is successfully received then the out of band module 14 confirms that agency authentication is successful.

The above mentioned process is discussed in more detail in the applicant's co-pending SA application numbers 2012/06340 and 2013/01027, the contents of which are incorporated herein by reference.

### Transaction Authorisation

Referring now to transaction authorisation, this is carried out by a transaction authorisation module 25 which accesses the memory 12 to check the status of a SIM card inserted into the mobile phone 18 from which the transaction authorisation is performed

At the time that the user 20 registers for use of the fraud prevention system, the identification of the SIM is obtained and stored in memory 12 along with a SIM status field.

In one embodiment of the invention, the unique identity of the SIM so captured and recorded is the SIM IMSI.

The SIM status field may be simply “verified” or “unverified” for example or may be a binary or other code representing these statuses.

In a typical implementation, the SIM status is captured as follows:
1) SIM identity captured at time of user registration and SIM status is “verified”;
2) SIM swapped and identity verification process not completed, in which case SIM status is “unverified”; and
3) SIM swapped and identity verification process again completed after which SIM status reverts to “verified”.

The first status referred to above is essentially an “in use” type of status that confirms the SIM card in question was in use at the time that the fraud prevention system was implemented or at the time that the user registered as a new user on the system.

When the SIM card is swapped, the Mobile Network Operator could be contracted to inform us alternatively the transaction authorisation module 25 will determine that the SIM has been swapped by comparing the IMSI stored in the memory 12 with the IMSI currently being used. Thus the system is kept up to date with mobile network information and when the SIM card is swapped at the network, the system is immediately updated with this change, the SIM status is updated to “unverified”, and the system sets a verification process in motion, which is preferably the customer identification programme outlined above.

In order to obtain a “verified” status, the user is either contacted or contacts a call centre where the user is put through the customer identification programme. In this example, a system operator is notified by the system to implement the verification process by calling the user.

Financial institutions typically have a large amount of a user's personal information available and the user is asked a number of questions relating to their personal information. Once all of the questions are answered correctly, the call centre agent accesses the server 10 and changes the SIM status back to “verified”.

It will be appreciated that the verification can also be done via SMS, STK, USSD, WAP or the Internet as outlined above, to name but a few examples.

It will be appreciated that this SIM status is essentially used to indicate that the SIM is properly associated with the verified user. Furthermore, the transaction authorisation module 25 confirms that SIM authentication is successful based on the SIM status stored in the memory 12.

### Location-Based Transaction Verification

The final layer in the security process is based on location and is implemented by the location module 26.

The location module 26 compares the geographic location of the mobile telephone 18, at the time agency authentication is completed, with the transaction initiation location. This is the geographic location from where the financial transaction is initiated.

If the geographic location of the mobile phone 18 is within a predetermined proximity to the initiation location then the location module 26 confirms that location authentication is successful.

The geographic location of the mobile phone 18 is easily determined using existing locating technology.

Existing geographic locating technology includes GPS and systems that use multilateration of radio signals, such as between radio towers of the network and the phone.

The determination of the initiation location of the financial transaction will depend on the type of financial transaction that has been initiated and the source of the initiation.

For example, where the financial transaction is a payment where a credit card of the user has been swiped at a point of sale (POS) terminal, the geographic location is easily determined as the geographic location of the POS terminal is known or can be determined with relative ease.

Alternatively, the financial transaction may be an online banking payment which the user makes, for example using a computer 28.

In this example, the computer 28 will access the Internet and depending on the amount of information allowed by an Internet service provider used by the computer 28, either the specific geographic location such as a latitude and longitude or street address will be released by the Internet service provider or at least a slightly more general geographic location such as the vicinity or neighbourhood in which the computer 28 is located will be released by the Internet service provider.

It will be appreciated that the accuracy with which the initiation location can be determined will also determine the acceptable proximity within which the mobile phone 18 must be located.

If a specific location is obtainable then the mobile phone 18 must also be located at that location or in close proximity.

If only a network location is obtainable then the mobile phone 18 must be located in proximity to that location.

### Transaction Authorisation

Finally, an authorising module 30 authorises the requested financial transaction only if all of the agent authentication, SIM authentication and location-based transaction verification as described above are successful.

### EXEMPLARY EMBODIMENT

A practical example of the fraud prevention system in action is described as follows.

A user 20 enters a shop and purchases goods or services. The user produces a credit card or a near field communications (NFC) enabled phone to make a payment, typically at a point of sale machine used by a vendor based at a particular geographic location.

The transaction is routed to the server 10 for authorisation.

The authorisation process first implements agent authentication—the authorisation request includes data identifying the user 20, either by way of user-identifying data derived from the credit card or, where payment is made by phone, user-identifying data derived from the phone. The user-identifying data is transmitted as part of the transaction authorisation request. The system then implements the agent authentication process outlined above.

Based on the user identity data received, the memory 12 is accessed to obtain the communications routing number of the mobile phone 18 (the MSISDN) of the user to enable the system to implement the transaction authorisation process outlined above. In this process, once the system obtains the communications routing number of the mobile phone 18 of the requesting user 20, the system initiates a network initiated USSD challenge/response session with the mobile phone 18. In the USSD session, the user is provided with details of the transaction and asked to either accept or decline the transaction, where if accept the user is requested to enter a pin, otherwise if decline, the process ends

This data is passed back to server 10 and based on the response, agency authentication either passes or fails, as described above.

Assuming agency authentication is successful, the server 10 will also check the SIM card status and if the status is verified, SIM authentication is successful.

Finally, the server 10 performs location verification to determine the geographic location of the mobile phone 18 and the geographic location of the transaction, whereupon the system compares the two locations to determine whether or not the geographic location of the mobile phone 18 is within a predetermined proximity to the geographic location of the transaction. If this is the case then location-based transaction verification is also successful.

It will be appreciated that the order in which these authentication processes are actually carried out by the server may be altered from the order in which they are described above. In any event, with all three authentication steps successful, the transaction is authorised and payment from the user to the vendor is processed.

The server 10 can either be implemented by a financial institution that processes financial transactions or could be implemented by a third party server that is connected to a financial institution via a secure communications network.

It will be appreciated that whilst the user will be aware of the agent authentication as they will be interacting with the mobile phone 18 for this, they will not be aware of the SIM authentication or the location-based transaction verification which will be happening in the background. Finally, it will be appreciated that with the application of all three layers of security, the electronic fraud prevention system provides a formidable system for fraudsters to overcome to allow them to fraudulently process financial transactions.

### Card not Present (CNP) Transaction Authentication

This is a security option for card not present transactions conducted by voice over the phone 18.

The user 20 is authenticated through the same layered security system as outlined above, with the exception that the transaction authorisation process can use an interactive voice response (IVR) system for the challenge/response session. This allows implementation of the agent authentication and transaction authorisation processes over the phone 18, without the user having to interrupt the voice call.

In this implementation, online card not present transactions can also be processed in conjunction with the 3D Secure card payment protocol and the Access Control Server functions associated therewith on the issuer (bank) side of the transaction, to enable authentication of the user using the agent authentication process of this invention. Having gone through the customer identification programme, the user 20 can opt to enter a YES/NO choice then a PIN over the mobile phone 18 instead of the normal 3D Secure process as before. With the above, the user still receives layered security through the other layers of the system of the invention (transaction authorisation; location-based transaction verification) and PIN entry is that much more secure.

### Card Present Transaction Authentication

Whilst the layered security design of the system of the invention (agent authentication; transaction authorisation; location-based transaction verification) is the standard operation of the system, it is possible to process this category of transactions without the need for mobile device interaction (interactive challenge/response transaction authorisation).

Since the user is interacting with a physical interface, be it an ATM or POS terminal, where they are required to insert or swipe a card and enter a PIN, the entry of a PIN over the mobile channel in a secondary communication is essentially superfluous and serves merely to prolong the transaction time unnecessarily. In this instance, the user can be authenticated by way of the card and PIN since this includes the agent authentication process of the system of the invention. In addition, the transaction can be verified using the SIM authentication and location-based transaction verification process.

I claim:

1. A system to prevent fraud in an electronic transaction, the system comprising:
programmable logic means including a memory module, a communications module, an out of band module, a transaction authorisation module, a location module and an authorising module;
the communications module being configured to receive a request to process an electronic transaction authorisation initiated by a user of both financial services and a mobile communications device;
the out of band module being configured, in response to receiving the request, to access the memory module to obtain a communications routing number associated with the mobile communications device;
the programmable logic means being configured to initiate a secondary communications session over a secondary communications channel with the mobile communications device and, by way of the communications module, to transmit a request for authorisation data to the mobile communications device and to receive authorisation data from the mobile communications device by way of the secondary communications channel, wherein if the authorisation data is successfully received then a password module confirming that agent authentication is successful;
the transaction authorisation module being configured to access the memory module to determine the status of a SIM card associated with the mobile communications device from which the authorisation data is received, the transaction authorisation module being configured to confirm that SIM authentication is successful based on the SIM status stored in the memory module;
the location module being configured to compare the geographic location of the mobile telephone at the time agent authentication is completed with an initiation location, being the geographic location from where the financial transaction is initiated, wherein if the geographic location of the mobile communications device is within a predetermined proximity to the initiation location then confirming that location-based transaction verification is successful; and
the authorising module being configured to authorise the requested financial transaction only if all of agent authentication, SIM authentication and location-based transaction verification are successful.

2. The fraud prevention system of claim 1 wherein the transaction authorisation module at a time that the user registers for use of the fraud prevention system obtains the identification of the SIM and stores this in the memory and updates the SIM status field.

3. The fraud prevention system of claim 1 wherein the unique identity of the SIM is the international mobile subscriber identity (IMSI).

4. The fraud prevention system of claim 1 wherein the SIM status stored in the memory module is stored as “verified” or “unverified”.

5. The fraud prevention system of claim 4 wherein the transaction authorisation module is configured to change the SIM status stored in the memory module to “unverified” and to prompt the system to implement a user identity verification process when, in use, the user does a SIM swap.

6. The fraud prevention system of claim 1 wherein the location module uses either or both radio signals between several radio towers of a mobile network and the mobile communications device and GPS to determine the geographic location of the mobile communications device.

7. The fraud prevention system of claim 1 wherein the location module determines the initiation location of the financial transaction by accessing a memory and retrieving the stored location of a point of sale (POS) terminal or other transaction point from which the financial transaction authorisation request was received.

8. The fraud prevention system of claim 1 wherein the location module determines the initiation location of the financial transaction by determining the geographic location of a computer on a network from where the financial transaction authorisation request originated.

9. A method of preventing fraud in an electronic transaction, the method comprising the steps of:
in response to receiving a financial transaction authorisation request, accessing a memory to obtain a mobile communications device number associated with a user and for initiating a secondary communications session over a secondary communications channel with the mobile communications device;
in the secondary communications session, transmitting a request for authorisation data, via the communications module, to the mobile communications device and receiving authorisation data, via the communications module, from the mobile communications device via the secondary communications channel, wherein if the authorisation data is successfully received then confirming that agent authentication is successful;
accessing a memory to check the status of a SIM card associated with the mobile communications device from which the financial transaction authorisation request is received, wherein SIM authentication is successful based on the status stored in the memory;
comparing the geographic location of the mobile telephone at the time the agency authentication is completed with an initiation location, being a geographic location from where the financial transaction was initiated, wherein if the geographic location of the mobile communications device is within a predetermined proximity to the initiation location then confirming that location-based transaction verification is successful; and
authorising the requested financial transaction only if all of the agency authentication, SIM authentication and location-based transaction verification are successful.

10. The electronic fraud prevention method of claim 9 including the steps of, at a time that the user registers for use of the fraud prevention system, obtaining the identification of the SIM, storing this in the memory and updating the SIM status information in the memory.

11. The electronic fraud prevention method of claim 9 including the step of storing in the memory module, as the unique identity of the SIM, the international mobile subscriber identity (IMSI).

12. The electronic fraud prevention method of claim 11 including the step of, when the user does a SIM swap, changing the SIM status stored in the memory module to “unverified” and implementing a user identity verification process.

13. The electronic fraud prevention method of claim 9 including the steps of using either or both radio signals between several radio towers of a mobile network and the mobile communications device and GPS to determine the geographic location of the mobile communications device.

14. The electronic fraud prevention method of claim 9 including the step of determining the initiation location of the financial transaction by accessing a memory and retrieving the stored location of a point of sale (POS) terminal or other transaction point from which the financial transaction authorisation request was received.

15. The electronic fraud prevention method of claim 9 including the step of determining the initiation location of the financial transaction by the geographic location of a computer on a network from where the financial transaction authorisation request originated.
